(19) United States
(12) Patent Application Publication
(10) Pub. No.: US 2012/0120023 A1
(43) Pub. Date: May 17, 2012

(54) TOUCH-SCREEN DISPLAY APPARATUS AND COVER LENS AND ASSEMBLING METHOD THEREOF

(75) Inventors: Yung-li Huang, Wugu (TW); Chun-pin Liu, Wugu (TW); Yu-chieh Peng, Wugu (TW); Chia-chi Yeh, Wugu (TW)

(73) Assignee: HANNSTAR DISPLAY CORPORATION, WUGU (TW)

(21) Appl. No.: 13/102,045

(22) Filed: May 5, 2011

(30) Foreign Application Priority Data
Nov. 17, 2010 (TW) 099139536

(51) Int. Cl. G06F 3/042; B32B 37/12; B32B 3/30

(52) U.S. Cl. 345/175; 428/156; 156/91

(57) ABSTRACT

A touch screen display apparatus and a cover lens and an assembling method thereof are disclosed. The apparatus comprises the cover lens, a touch panel, a display panel and a backlight module. The cover lens comprises a plate body, a display area and a plurality of engage elements. The engage elements are disposed on one side of the plate body and around the display area for engaging with the backlight module. In the assembling method of the apparatus, the touch panel and the display panel are firstly disposed on the cover lens, and then the backlight module is engaged with the cover lens.

### FIELD OF THE INVENTION

The present invention relates to a touch-screen display apparatus, a cover lens thereof and an assembling method thereof, and more particularly, to a touch-screen display apparatus, a cover lens thereof and an assembling method thereof capable of enhancing the assembly quality.

### BACKGROUND OF THE INVENTION

Currently, the touch-screen technology has been widely applied in electrical products to be an input manner thereof. In this way, a user can use a finger or a stylus to touch a display panel for transmitting and displaying information at the same time.

The touch-screen display apparatus may comprise a cover lens, a touch panel and a display apparatus. The cover lens is configured to protect the touch-screen display apparatus from being damaged. The touch panel is configured to sense a touch and movement of a detected object. The display apparatus may be a liquid crystal display (LCD) which comprises an LCD panel and a backlight module for displaying images. The cover lens, the touch panel and the display apparatus are assembled as one piece by using an adhesive, such as an optically clear adhesive (OCA). The adhesive is required to be uniformly formed on a rear surface of the cover lens, two side surfaces of the touch panel and a surface of the display apparatus, so as to bond the cover lens, the touch panel and the display apparatus as one piece.

In general, when assembling the touch-screen display apparatus, the LCD panel and the backlight module of the display apparatus are firstly assembled, and then the cover lens and the touch panel are assembled thereon. However, the backlight module of the display apparatus is not a perfect board structure, and has a weaker structural strength. Therefore, when bonding the cover lens, the touch panel and the display apparatus, an uneven pressing between the touch panel and the display apparatus is likely to occur, resulting in an uneven thickness of the optical adhesive, an uneven bonding or an uneven surface, and further deteriorating the display effect and performance of the touch-screen display apparatus.

### SUMMARY OF THE INVENTION

Therefore, an aspect of the present invention is to provide a touch-screen display apparatus, a cover lens thereof and an assembling method thereof for utilizing a plurality of engaging elements of the cover lens to directly assemble with a backlight module, thereby enhancing the assembly quality thereof.

According to an embodiment of the present invention, the cover lens of a touch-screen display apparatus comprises a plate body having a display area; and a plurality of engaging elements disposed on one side of the plate body and positioned around the display area for engaging and assembling with a backlight module.

In one embodiment of the present invention, the display area is a transparent area.

In one embodiment of the present invention, the engaging elements comprise at least one bar disposed around the display area.

In one embodiment of the present invention, the engaging elements comprise at least one engaging unit disposed on the at least one bar.

In one embodiment of the present invention, the backlight module includes at least one engaging portion configured to be engaged with the at least one engaging unit.

According to another embodiment of the present invention, the touch-screen display apparatus comprises a cover lens comprising a plate body having a display area; and a plurality of engaging elements disposed on one side of the plate body and positioned around the display area; a touch panel disposed on the side of the cover lens; a display panel disposed on the touch panel; and a backlight module disposed on the display panel being engaged and assembled with the engaging elements of the cover lens.

In one embodiment of the present invention, the touch-screen display apparatus further comprises a first optical adhesive layer formed between the cover lens and the touch panel.

In one embodiment of the present invention, the touch-screen display apparatus further comprises a second optical adhesive layer formed between the touch panel and the display panel.

In one embodiment of the present invention, the backlight module includes a plurality of engaging portions configured to be engaged with the engaging elements of the cover lens.

According to a further embodiment of the present invention, the assembling method of a touch-screen display apparatus comprises the following steps: providing a cover lens, wherein the cover lens comprises a plurality of engaging elements being disposed on one side of the cover lens and positioned around a display area; arranging a touch panel on the side of the cover lens; arranging a display panel on the touch panel; and arranging a backlight module on the display panel, wherein the backlight module is engaged and assembled with the engaging elements of the cover lens.

Therefore, with the use of the touch-screen display apparatus, the cover lens and the assembling method thereof, the backlight module can be engaged and assembled with the engaging elements of the cover lens for improving the problems, such as unevenly pressing and unevenly bonding resulting from the conventional assembly, and significantly enhancing the assembly quality of the touch-screen display apparatus.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an exploded perspective view showing a touch-screen display apparatus according to an embodiment of the present invention;

FIG. 2 is a perspective view showing the cover lens according to an embodiment of the present invention;

FIG. 3 is a perspective view showing a backlight module according to an embodiment of the present invention;

FIG. 4 is a perspective view showing a touch-screen display apparatus according to an embodiment of the present invention; and

FIG. 5 is a flow diagram showing an assembling method of the touch-screen display apparatus according to an embodiment of the present invention.

### DETAILED DESCRIPTION OF THE PREFERRED EMBODIMENT

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

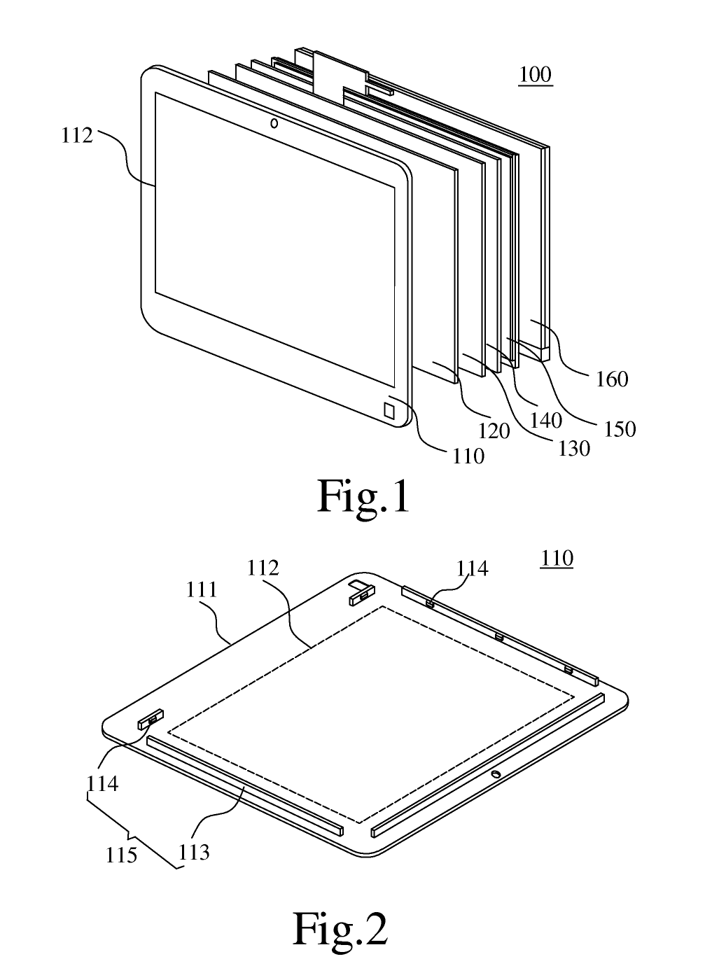

Referring to FIG. 1, an exploded perspective view showing a touch-screen display apparatus according to an embodiment of the present invention is illustrated. The touch-screen display apparatus 100 of the present embodiment can comprise a touch-control function and an image display function. The touch-screen display apparatus 100 can comprise a cover lens 110, a first optical adhesive layer 120, a touch panel 130, a second optical adhesive layer 140, a display panel 150 and a backlight module 160. The cover lens 110 is configured to protect the structure of the touch-screen display apparatus 100. The first optical adhesive layer 120 is configured to bond the cover lens 110 and the touch panel 130 together. The touch panel 130 is configured to implement the touch-control function. The second optical adhesive layer 140 is configured to bond the touch panel 130 and the display panel 150. The display panel 150 is configured to display images. The backlight module 160 is configured to provide a backlight to the display panel 150 and assembled with the cover lens 110.

Referring to FIG. 2, a perspective view showing the cover lens according to an embodiment of the present invention is illustrated. The cover lens 110 may be disposed at an outer side of the touch-screen display apparatus 100 for protecting and packaging the structure thereof, and may have functions, such as scratch resistant, anti moisture, anti-glare, anti-static and anti-reflective functions. The cover lens 110 can comprise a plate body 111 and a plurality of engaging elements 115, wherein the plate body 111 has a display area 112, and the engaging elements 115 comprise at least one bar 113 and a plurality of engaging units 114. The plate body 111 may be a rectangular plate body which is preferably made of a material with a high strength, such as a glass, a carbon fiber, a metal, a reinforced plastic or any combination thereof. At least a portion of the area of the plate body 111 is transparent (such as the display area 112) for displaying images. The display area 112 is a transparent area formed on the plate body 111 for displaying the images formed by the display panel 150. The display area 112 may be formed at the center of the plate body 111 corresponding to the touch panel 130 and the display panel 150. When using the touch-screen display apparatus 100, a user can utilize a finger or other objects to touch or move within the display area 112, and watch the images shown from the display area 112 of the cover lens 110. An area outside the display area 112 of the cover lens 110 can be opaque for sheltering the undesired light.

Referring to FIG. 2 again, the at least one bar 113 of the engaging elements 115 of the cover lens 110 of the present embodiment are disposed on one side of the plate body 111 where the user can not touch, i.e. a rear surface of the cover lens 110. The at least one bar 113 is disposed around the display area 112, and the display panel 150 and the backlight module 160 are disposed between the at least one bar 113. The touch panel 130, the display panel 150 and the backlight module 160 are disposed above the display area 112. Therefore, the at least one bar 113 can be utilized to position the touch panel 130, thus having an assembly positioning effect. The at least one bar 113, made of material such as plastic, may be formed on the rear surface of the plate body 111 as one piece. Alternatively, the at least one bar 113 may be mounted on the plate body 111 by adhering or embedding.

In this embodiment, the at least one bar 113 of the engaging elements 115 of the cover lens 110 may be three long bars and two short bars being disposed around the display area 112. However, in one embodiment, the at least one bar 113 may be a ring-like bar disposed around the display area 112.

Referring to FIG. 2 again, the engaging units 114 of the engaging elements 115 of the cover lens 110 of the present embodiment are disposed on a side surface (the rear surface) of the plate body 111 and around the display area 112 for engaging and assembling with the backlight module 160, thus assembling the backlight module 160 on the display area 112. In this embodiment, the engaging units 114 are formed on the bars 113 for engaging and holding the backlight module 160. However, in other embodiments, the engaging units 114 are directly formed on the rear surface of the plate body 111 for engaging with the backlight module 160. In this embodiment, the engaging units 114 may be engaging bumps disposed on the inner sidewall of the bars 113. Furthermore, preferably, the engaging units 114 are separately disposed around the display area 112, so as to securely engage and assemble with the backlight module 160 on the display area 112, and thus reduce the between of the components.

In this embodiment, the engaging units 114, made of material such as plastic, may be formed on the bars 113 (such as plastic bars) as one piece. Alternatively, the engaging units 114 may be mounted on the plate body 111 or the bars 113 by adhering or embedding.

Referring to FIG. 1 again, the first optical adhesive layer 120 and the second optical adhesive layer 140 of the present embodiment may be optical adhesives. The first optical adhesive layer 120 is formed between the cover lens 110 and the touch panel 130 for bonding the cover lens 110 and the touch panel 130 together. The second optical adhesive layer 140 is formed between the touch panel 130 and the display panel 150 for bonding the touch panel 130 and the display panel 150 together.

Referring to FIG. 1 again, the touch panel 130 of the present embodiment is disposed on the rear surface of the cover lens 110 by using the first optical adhesive layer 120, and positioned to the display area 112 for sensing the touch or movement of the finger or an object to implement the touch-control function. The display panel 150 is disposed on the touch panel 130 by using the second optical adhesive layer 140, and the display panel 150 may be an LCD panel.

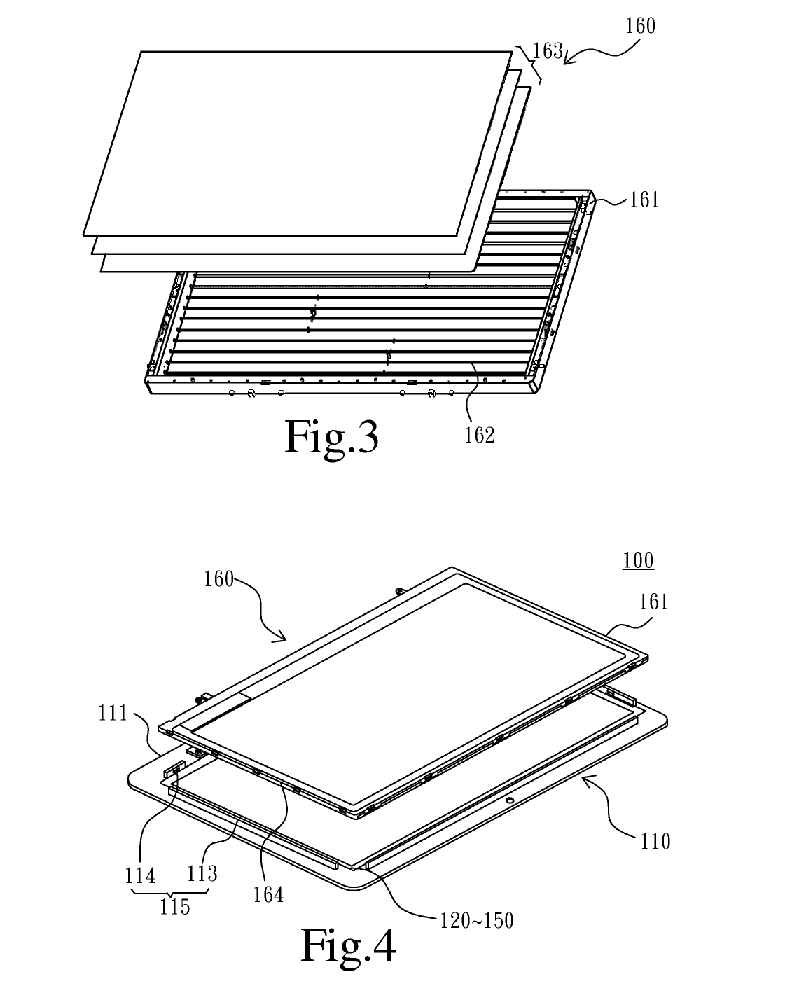

Referring to FIG. 3 and FIG. 4, FIG. 3 is a perspective view showing a backlight module according to an embodiment of the present invention, and FIG. 4 is a perspective view showing a touch-screen display apparatus according to an embodiment of the present invention. The backlight module 160 is disposed on the display panel 150, and engaged and assembled with the engaging units 114 of the cover lens 110. The backlight module 160 may be a side-light type or a direct-light type backlight module for providing a backlight to the display panel 150. The backlight module 160 can include a back bezel 161, a plurality of light sources 162, at least one optical film 163 and a plurality of engaging portions 164. The back bezel 161 may be made of a plastic or metal material. The light sources 162 are disposed in the back bezel 161 for emitting light to the display panel 150. The at least one optical film 163 is disposed above the back bezel 161 for improving the backlight. The engaging portions 164 are formed on the back bezel 161 for correspondingly engaging with the engaging units 114 of the cover lens 110. The light sources 162 may be cold cathode fluorescent lamps (CCFL), light emitting diodes (LED), organic light emitting diodes (OLED), or electro-luminescence (EL) devices. The optical film 163 may be a diffuser, a prism sheet, a turning prism sheet, a brightness enhancement film (BEF), a dual brightness enhancement film (DBEF), a diffused reflective polarizer film (DRPF) or any combination thereof.

Referring to FIG. 4 again, in this embodiment, the engaging portions 164 of the backlight module 160 may be engaging concave portions formed on the edge of the back bezel 161, and the engaging portions 164 are positioned corresponding to the engaging units 114 of the cover lens 110. In this way, the engaging units 114 of the cover lens 110 can be correspondingly inserted in and engaged with the engaging concave portions 164. Therefore, backlight module 160 can be correspondingly assembled with the display panel 150 by using the engaging units 114 of the cover lens 110.

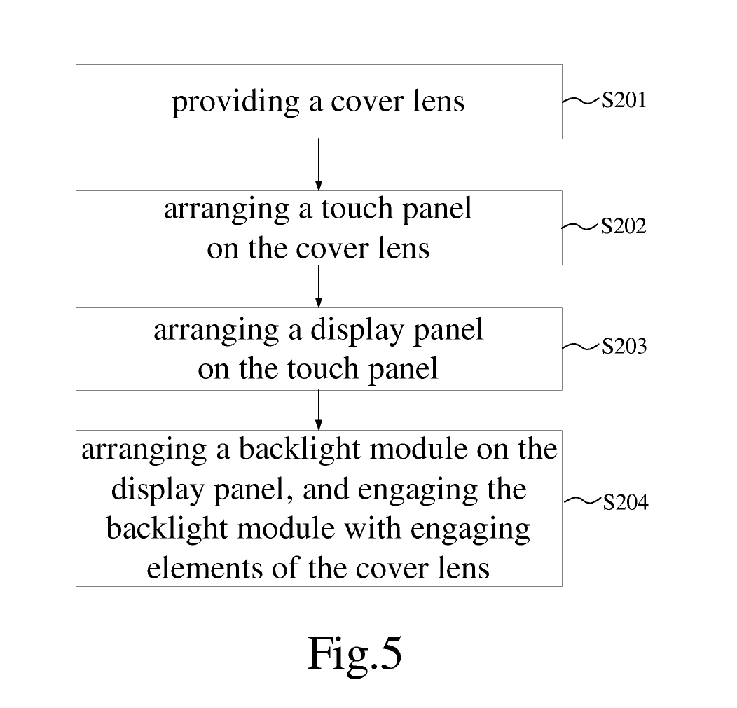

FIG. 5 is a flow diagram showing an assembling method of the touch-screen display apparatus according to an embodiment of the present invention. When assembling the touch-screen display apparatus 100, firstly, the cover lens 110 is provided (step S201). Subsequently, the touch panel 130 is arranged on the rear surface of the cover lens 110 (step S202). The touch panel 130 can be positioned to the display area 112 of the cover lens 110 by using the at least one bar 113, and bonded with the cover lens 110 by using the first optical adhesive layer 120. Subsequently, the display panel 150 is arranged on the touch panel 130 (step S203). Similarly, the display panel 150 can also be positioned on the touch panel 130 by using the at least one bar 113, and bonded with the touch panel 130 by using the second optical adhesive layer 140. Before, the touch panel 130 and the display panel 150 are stacked on the cover lens 110 in sequence, the backlight module 160 is arranged on the display panel 150 and engaged with the engaging units 114 of the cover lens 110 (step S204). At this time, the backlight module 160 can be arranged on the stack of the touch panel 130 and the display panel 150, and correspondingly engaging with the engaging units 114 of the cover lens 110.

In the assembling method of the touch-screen display apparatus of the present embodiment, the complete board structure (the touch panel 130 and the display panel 150) are first stacked (bonded) on the cover lens 110, thereby tightly assembling the cover lens 110, the touch panel 130 and the display panel 150 as one piece. Furthermore, the optical adhesive layers 120, 140 can also be pressed uniformly, so as to tightly bond the cover lens 110, the touch panel 130 and the display panel 150 together. Subsequently, the backlight module 160 can be securely assembled with the touch panel 130 and the display panel 150 by using the engaging units 114 of the cover lens 110, thereby forming the touch-screen display apparatus 100 of the present embodiment.

Therefore, the cover lens 110 of the present embodiment can first allow the touch panel 130 and the display panel 150 to be stacked on the display area 112 of the cover lens 110, and then use the engaging units 114 of the cover lens 110 to correspondingly engage with the backlight module 160 on the display panel 150 for improving the non-uniform bonding problem resulted from the conventional assembly. In this way, it is possible to enhance the assembly quality of the touch-screen display apparatus 100.

In one embodiment, according to the design or size of the touch-screen display apparatus 100, the first optical adhesive layer 120 and/or second optical adhesive layer 140 thereof may be omitted. At this time, the touch panel 130 and the display panel 150 are first stacked on the display area 112 of the cover lens 110, and then correspondingly engaged with the backlight module 160 by using the engaging units 114 of the cover lens 110, thereby securely forming the touch-screen display apparatus 100.

As described above, with the touch-screen display apparatus, the cover lens and the assembling method thereof, the touch panel and the display panel are first positioned and disposed on the cover lens, and then engaged and assembled with the backlight module by using the engaging elements of the cover lens for improving the problems, such as uneven pressing and uneven bonding, resulted from the conventional assembly, and enhancing the assembly quality of the touch-screen display apparatus.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A cover lens of a touch-screen display apparatus comprising:
a plate body having a display area; and
a plurality of engaging elements disposed on one side of the plate body and positioned around the display area for engaging and assembling with a backlight module.

2. The cover lens as claimed in claim 1, wherein the display area is a transparent area.

3. The cover lens as claimed in claim 1, wherein the engaging elements comprise at least one bar disposed around the display area.

4. The cover lens as claimed in claim 3, wherein the engaging elements comprise at least one engaging unit disposed on the at least one bar.

5. The cover lens as claimed in claim 1, wherein the backlight module includes at least one engaging portions configured to be engaged with the at least one engaging unit.

6. A touch-screen display apparatus comprising:
a cover lens comprising:
a plate body having a display area; and
a plurality of engaging elements disposed on one side of the plate body and positioned around the display area;
a touch panel disposed on the side of the cover lens;
a display panel disposed on the touch panel; and
a backlight module disposed on the display panel and engaged and assembled with the engaging elements of the cover lens.

7. The touch-screen display apparatus as claimed in claim 6, further comprising:
a first optical adhesive layer formed between the cover lens and the touch panel.

8. The touch-screen display apparatus as claimed in claim 6, further comprising:
a second optical adhesive layer formed between the touch panel and the display panel.

9. The touch-screen display apparatus as claimed in claim 6, wherein the backlight module includes a plurality of engaging portions configured to be engaged with the engaging elements of the cover lens.

10. An assembling method of a touch-screen display apparatus comprising the following steps:
providing a cover lens, wherein the cover lens comprises a plurality of engaging elements disposed on one side of the cover lens and positioned around a display area;
arranging a touch panel on the side of the cover lens;
arranging a display panel on the touch panel; and
arranging a backlight module on the display panel, wherein the backlight module is engaged and assembled with the engaging elements of the cover lens.
